(19) United States
(12) Patent Application Publication
(10) Pub. No.: US 2024/0149203 A1
(43) Pub. Date: May 9, 2024

(54) Air Filter Arrangement; Assembly; and, Methods

(71) Applicant: Donaldson Company, Inc., Bloomington, MN (US)

(72) Inventors: Gregory Reichter, Bloomington, MN (US); Wayne R.W. Bishop, St. Louis Park, MN (US); Benny Nelson, Bloomington, MN (US); Darrel Wegner, Burnsville, MN (US); Bruce Crenshaw, Frankfurt, IN (US); Vladimir Kladnitsky, Eagan, MN (US); Donald Mork, Lime Springs, MN (US); Kevin Schrage, Spring Valley, MN (US); Richard Osendorf, West St. Paul, MN (US); Bradley Kuempel, Eden Prairie, MN (US); Thomas Lundgren, Bloomington, MN (US); Jordan Flagstad, East Bethel, MN (US); Thomas G. Miller, Eagan, MN (US)

(21) Appl. No.: 18/488,129

(22) Filed: Oct. 17, 2023

Related U.S. Application Data
(63) Continuation of application No. 17/101,996, filed on Nov. 23, 2020, now Pat. No. 11,826,689.
Application No. 17/101,996 is a continuation of application No. 16/119,121, filed on Aug. 31, 2018, now Pat. No. 10,864,475.
Application No. 16/119,121 is a continuation of application No. 14/935,860, filed on Nov. 9, 2015, now Pat. No. 10,065,145.
Application No. 14/935,860 is a continuation of application No. 14/165,042, filed on Jan. 27, 2014, now Pat. No. 9,180,399.
Application No. 14/165,042 is a continuation of application No. 13/952,987, filed on Jul. 29, 2013, now Pat. No. 8,636,820.
Application No. 13/952,987 is a continuation of application No. 11/795,178, filed on Jul. 29, 2008, now Pat. No. 8,496,723.
(60) Provisional application No. 60/644,094, filed on Jan. 13, 2005.

(51) Int. Cl. B01D 46/52; B01D 46/00

(52) U.S. Cl. CPC B01D 46/526; B01D 46/0005; B01D 2271/022

(57) ABSTRACT

An air cleaner arrangement is shown. The air cleaner arrangement includes a serviceable filter cartridge. A preferred filter cartridge positionable within an air cleaner arrangement, is depicted.

This application is a continuing application of U.S. Ser. No. 17/101,996, filed Nov. 23, 2020. U.S. Ser. No. 17/101,996 is a continuation of U.S. Ser. No. 16/119,121, filed Aug. 31, 2018, now U.S. Pat. No. 10,864,475. U.S. Ser. No. 16/119,121 is a continuation of U.S. Ser. No. 14/935,860, filed Nov. 9, 2015, now U.S. Pat. No. 10,065,145. U.S. Ser. No. 14/935,860 is a continuation of U.S. Ser. No. 14/165,042, filed Jan. 27, 2014, now U.S. Pat. No. 9,180,399. U.S. Ser. No. 14/165,042 was a continuation of U.S. Ser. No. 13/952,987, filed Jul. 29, 2013, now U.S. Pat. No. 8,636,820. U.S. Ser. No. 13/952,987 was a continuation of U.S. Ser. No. 11/795,178, now U.S. Pat. No. 8,496,723. U.S. Ser. No. 11/795,178, filed 12 Jul. 2007, was a National Stage Patent Application of PCT International Patent application number PCT/US2006/001021 filed on 12 Jan. 2006 and claiming priority from 60/644,094, filed Jan. 13, 2005. The complete disclosures of the above-referenced applications are incorporated herein by reference. A claim of the priority to each of the above referenced applications is made to the extent appropriate.

### FIELD OF THE DISCLOSURE

The present disclosure relates to air cleaners. The disclosure particularly relates to air cleaners with media packs that use z-filter media comprising a fluted (typically corrugated) media sheet secured to a facing sheet, formed into a media pack. More specifically, the disclosure relates to such media packs provided in serviceable filter cartridge arrangements, typically for use in air cleaners. Air cleaner arrangements, methods of assembly and use, and systems of use are also described.

### BACKGROUND

Air streams can carry contaminant material therein. In many instances, it is desired to filter some or all of the contaminant material from the air stream. For example, gas flow streams to engines (for example combustion air) for motorized vehicles or for power generation equipment, gas streams to gas turbine systems and air streams to various combustion furnaces, carry particulate contaminant therein that should be filtered. It is preferred for such systems, that selected contaminant material be removed from (or have its level reduced in) that gas. A variety of air filter arrangements have been developed for contaminant rejection. However, continued improvements are sought.

### SUMMARY

According to a portion of the present disclosure, features useable in air cleaners and filter cartridges for the air cleaners provided. The features can be used together to provide a system, however some advantageous arrangements can be constructed to use only selected ones of the features. In addition, methods of construction and use are provided.

In one aspect of the present disclosure, a preferred media pack is provided, for use in or as air filter cartridges. The media pack comprises a stacked z-filter arrangement having opposite flow faces and opposite sides. At a pair of the opposite sides, ends of stacked strips are sealed, for example by end pieces such as molded-in-place end pieces, although alternatives are possible. In some examples the molded end pieces would comprise molded polyurethane. Also, a useable housing seal arrangement is provided. The housing seal arrangement can be provided as a molded-in-place seal arrangement.

Also, air cleaner arrangements, which use the filter cartridge as a service component, are described. In addition, shown and described are features of an air cleaner system and for example an environment of use. Also methods of assembly and use are shown and described.

### BRIEF DESCRIPTION OF THE DRAWINGS

FIG. 1 is a schematic view of a system using an air cleaner assembly having a filter cartridge component according to the present disclosure.

FIG. 2 is a schematic perspective view of an air cleaner assembly according to the present disclosure.

FIG. 3 is a side elevational view of the air cleaner assembly depicted in FIG. 2.

FIG. 4 is an inlet end view of the air cleaner assembly depicted in FIGS. 2 and 3.

FIG. 5 is a schematic view of the air cleaner assembly depicted in FIGS. 2-4, with a housing portion shown in see-through to allow viewing of a positioning of an internally received filter cartridge component.

FIG. 6 is a side elevational view of the arrangement depicted in FIG. 5.

FIG. 7 is a cross-sectional view of the arrangement depicted in FIG. 6.

FIG. 8 is a schematic cross-sectional view analogous to FIG. 7, showing a possible housing seal location.

FIG. 9 is a schematic perspective view of a filter cartridge usable in the arrangement of FIG. 8.

FIG. 10 is a side view of the arrangement shown in FIG. 9.

FIG. 11 is an end view of the arrangement shown in FIG. 9.

FIG. 12 is an opposite end view from FIG. 11.

FIG. 13 is a view of an air flow face of the arrangement of FIG. 9.

FIG. 14 is a side perspective view of a second air cleaner according to the present disclosure.

FIG. 15 is an end perspective view of the air cleaner of FIG. 14.

FIG. 16 is an inlet end elevational view of the air cleaner of FIGS. 14 and 15.

FIG. 17 is an outlet end elevational view of the air cleaner of FIGS. 14 and 15.

FIG. 18 is a side elevational view of the air cleaner of FIGS. 14-17.

FIG. 19 is a cross-sectional view taken along line 19-19, FIG. 17.

FIG. 20 is a schematic perspective view of a filter cartridge useable in the air cleaner of FIGS. 14-19.

FIG. 21 is a side elevational view of the filter cartridge of FIG. 20.

FIG. 22 is a first end elevational view of the cartridge of FIG. 20.

FIG. 23 is a second, opposite, end view if the filter cartridge of FIG. 20.

### DETAILED DESCRIPTION

### I. Z-Filter Media Configurations, Generally

Air cleaners according to the present disclosure utilize a z-filter media construction. In general the term “z-filter construction” as used herein, and variants thereof, is meant to refer to a filter construction in which individual ones of corrugated, folded or otherwise formed filter flutes are used to define sets of longitudinal, typically parallel, inlet and outlet filter flutes for fluid flow through the media; the fluid flowing along the length of flutes between opposite inlet and outlet ends (or flow faces) on the media, during filtering. Some examples of z-filter media are provided in U.S. Pat. Nos. 5,820,646; 5,772,883; 5,902,364; 5,792,247; 5,895,574; 6,210,469; 6,190,432; 6,350,296; 6,179,890; and 6,235,195. The complete disclosures of these 10 cited references are incorporated herein by reference.

One type of z-filter media, uses two specific separate media components which are joined together, to form a media construction. The two components are: (1) a fluted (typically corrugated) media sheet; and (2) a facing media sheet. The facing media sheet is typically non-corrugated, however it can be corrugated, for example perpendicularly to the flute direction as described in U.S. Provisional 60/543,804 filed Feb. 11, 2004, incorporated herein by reference.

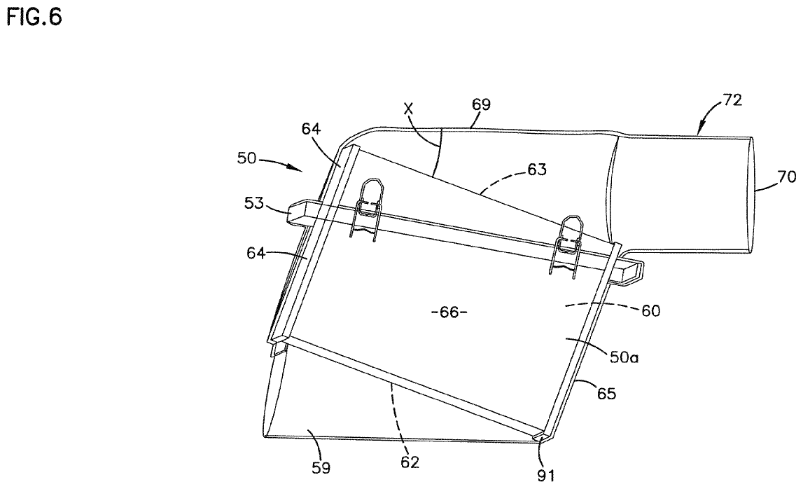

In typical preferred applications as described herein, the media pack comprises stacked strips (each strip, sometimes, called a single facer strip, being a section of fluted (corrugated) sheet secured to facing sheet) each strip extending generally (or approximately) in a plane parallel to the other strips. Such arrangements are described for example in U.S. Provisional Applications 60/599,686, filed Aug. 6, 2004; 60/600,081, filed Aug. 9, 2004; 60/602,721, filed Aug. 18, 2004; and 60/616,364, filed Oct. 5, 2004, the complete disclosures of which are incorporated herein by reference. An example is described, for example, in connection with FIG. 6 of U.S. Provisional 60/616,364, and related descriptions. Stacked arrangements according to the present disclosure can be made in general in accord with the descriptions therein.

Particular arrangements shown herein are “blocked” stacked arrangements, in that each end or side face of the stacked arrangement extends perpendicularly to adjacent faces. Such arrangements are shown for example in U.S. Provisional Application 60/616,364, filed Oct. 5, 2004, FIG. 6. Alternate arrangements can be used, for example, in which instead of being blocked, the layers of single facer sheet are stacked offset from one another to create a slanted arrangement.

In typical arrangements, the flutes extend between opposite flow faces, one being an inlet flow face and the opposite being an outlet flow face. Opposite ends of the strips are typically sealed, for example by being secured within end pieces. This is described in U.S. Provisional Patent Application 60/616,364, at FIG. 64, for example.

A housing seal is provided between the media pack and the air cleaner housing, as described below.

### II. Manufacture of Stacked Media Configurations Using Fluted Media, Generally

A process for manufacturing stacked media configurations using fluted media, is described in U.S. Provisional Application 60/616,364 in section II. Such techniques can be utilized to generate media packs useable in arrangements according to the present disclosure.

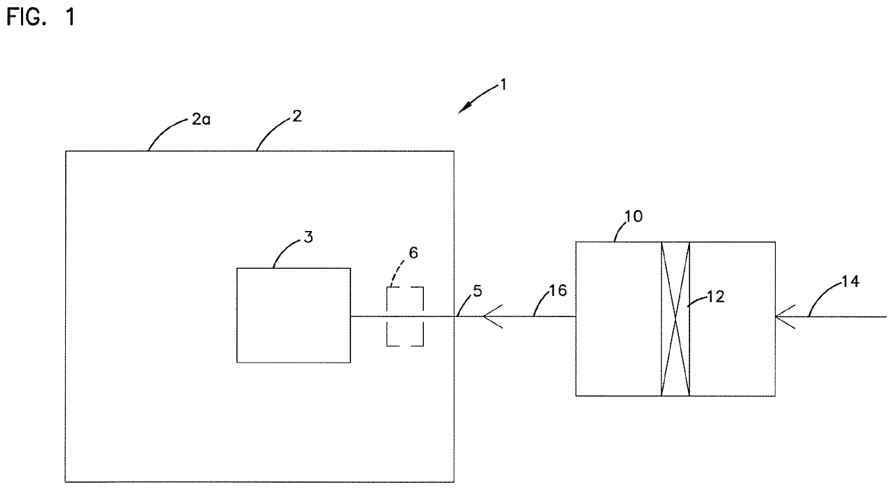

### III. An Example Air Cleaner System, FIGS. 1-13

### A. General System of Use.

The principles and arrangements described herein are useable in a variety of systems. One particular system is depicted schematically in FIG. 1, generally at 1. In FIG. 1, equipment 2, such as a vehicle 2a having an engine 3 with some defined rated air flow demand, for example in the range of 50 cfm to 2000 cfm (cubic feet per minute) (i.e., 1.4-57 cubic meters/minute) is shown schematically. Although alternatives are possible, the equipment 2 may, for example, comprise a bus, an over-the-highway truck, an off-road vehicle, a tractor, a light-duty or medium-duty truck, or a marine vehicle such as a power boat. The engine 3 powers the equipment 2 upon fuel combustion. In FIG. 1, air flow is shown drawn into the engine 3 at an air intake at region 5. An optional turbo 6 is shown in phantom, as optionally boosting the air intake to the engine 3. The turbo 6 is shown downstream from an air cleaner 10, although alternate arrangement are possible.

The air cleaner 10 has a serviceable (i.e., removable and replaceable) filter cartridge 12 and is shown in the air inlet stream to the engine 3. In general, in operation, air is drawn in at arrow 14 into the air cleaner 10 and through the filter cartridge 12. Upon passage through the air cleaner 10, selected particles and contaminants are removed from the air. The cleaned air then flows downstream at arrow 16 into the intake 5. From there, the air flow is directed into the engine 3.

In a typical air cleaner 10, the filter cartridge 12 is a serviceable component. That is, the cartridge 12 is removable and replaceable within the air cleaner 10. This allows the cartridge 12 to be serviced, by removal and replacement, with respect to remainder of air cleaner 10, when the cartridge 12 becomes sufficiently loaded with dust or other contaminant, to require servicing.

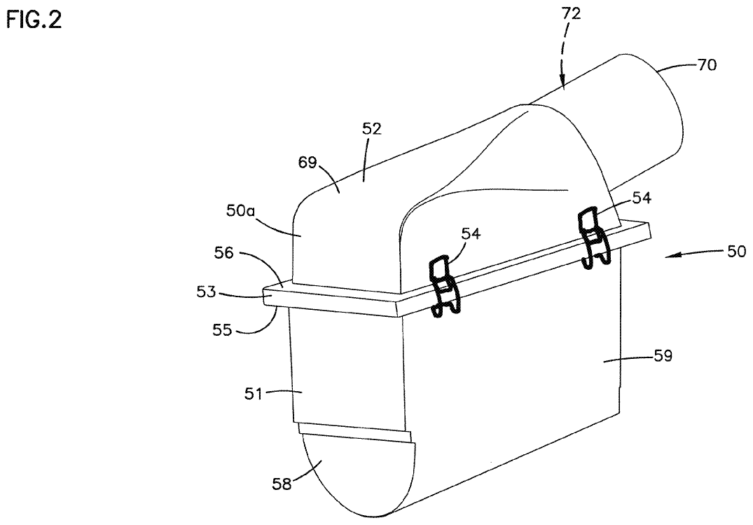

### B. An Example Air Cleaner Arrangement, FIGS. 2-13.

In FIG. 2, a cross-sectional, schematic, view of an air cleaner arrangement according to the present disclosure. Referring to FIG. 2, air cleaner arrangement 50 comprises housing 50a including inlet section 51 and outlet section 52. The inlet section 51 and outlet section 52 are secured to one another along housing separation region 53. Clamps 54 or other arrangements, can be used to secure connection at separation region 53.

For the arrangement shown, housing separation region 53 comprises a flange 55 on the inlet section 51, and a flange 56 on the outlet section 52 sized and configured to engage one another. Unhooking clamps 54 allows separation of flanges 55, 56 (and thus sections 51, 52) to obtain service access to an interior of housing 50a.

The inlet section 51 includes an air flow inlet 58 and a filter cartridge receiving section 59. The outlet section 52 includes a filter cartridge receiving section 69 and an outlet tube 70.

For the particular arrangement shown, the inlet tube 58 and outlet tube 70 extend in generally opposite directions from one another. Alternate constructions are possible.

In a typical assembly, inside of outlet tube 70, or in related duct work, at or near region 72, a probe of a mass air flow sensor system (MAFS) could be positioned, to evaluate air flow in outlet tube 70.

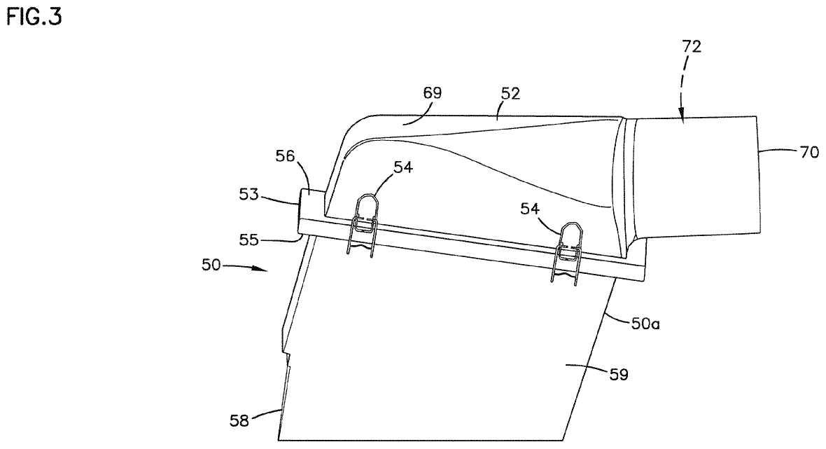

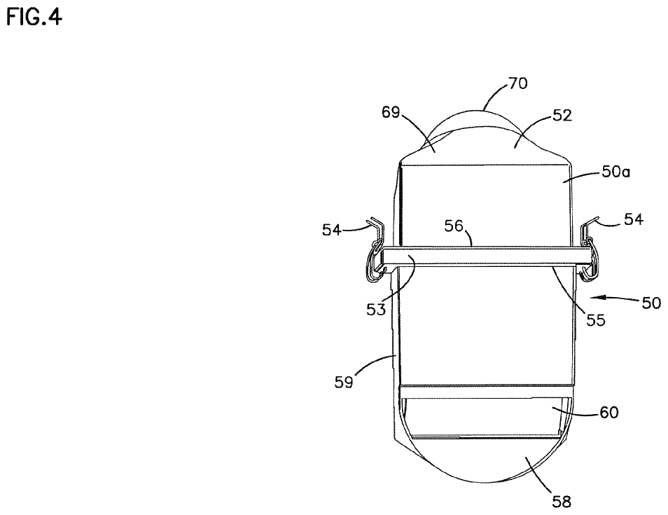

In FIG. 3, a side elevational view of air cleaner arrangement 50 is shown. In FIG. 4 an end view of air cleaner 50, directed toward inlet 58 is shown. In FIG. 4, a portion of a filter cartridge 60 positioned inside of air cleaner housing 50a is shown.

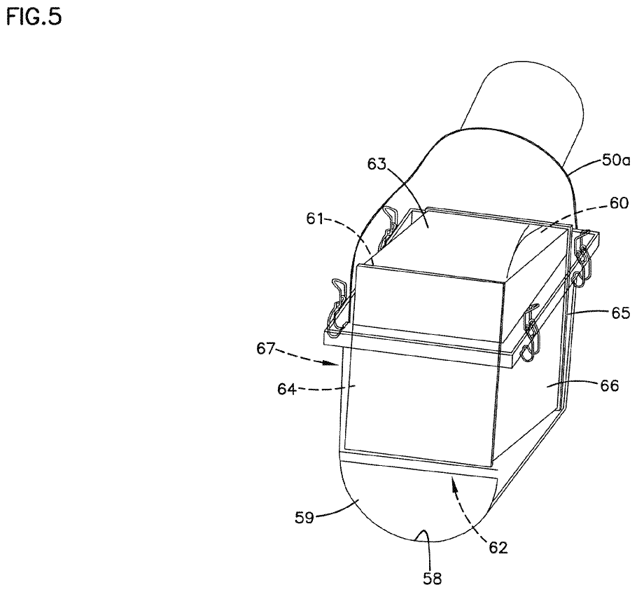

In FIG. 5, a schematic depiction of housing 50a is shown, with the housing 50a shown in a see-through form, so internally positioned filter cartridge 60 can be seen. Referring to FIG. 5, cartridge 60 comprises a z-filter media pack 61 having a inlet face 62, an outlet face 63, opposite ends 64, 65 and a pair of opposite faces 66, 67. Ends 64, 65 generally correspond to end sealant portions closing ends of single facer media forming the media pack 60.

Opposite faces 66, 67 are shown substantially uncovered, however a sheet of material or protective covering could be provided at these locations.

Generally, air is filtered by entering media pack 61 at inlet face 62 and exiting at opposite outlet face 63.

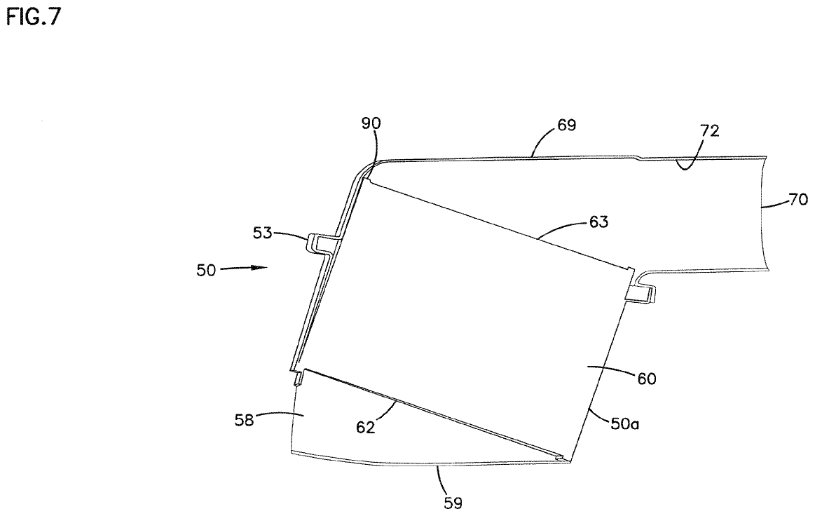

In FIG. 6, a side elevational view of the arrangement 50 as shown in FIG. 5, is depicted. In FIG. 7, a cross-sectional view of the arrangement shown in FIG. 6 is depicted.

It is desirable to configure air cleaner housing 50a and to position cartridge 60 therein, in a manner avoiding undesirable levels of air turbulence in region 72, which would negatively effect the operation of the MAFS. This is facilitated by:
1. Providing a stacked arrangement for cartridge 60 in which a coiled arrangement of corrugated media secured to facing media is avoided, but rather stacked strips of corrugated sheet secured to facing sheets are used, with each strip positioned at least approximately in a plane parallel to other strips.
2. Positioning outlet flow face 63, FIG. 6, partially angled toward outlet tube 70 as opposed to within a plane of separation region 53. Preferably the angle X between the outlet flow face 63 and outlet tube 70 is at least 10° typically at least 15° and often within the range of 15° to 80°, inclusive, for example 15°-40°, inclusive. A variety of arrangements can be used to position the cartridge 60 as shown schematically in FIG. 2.

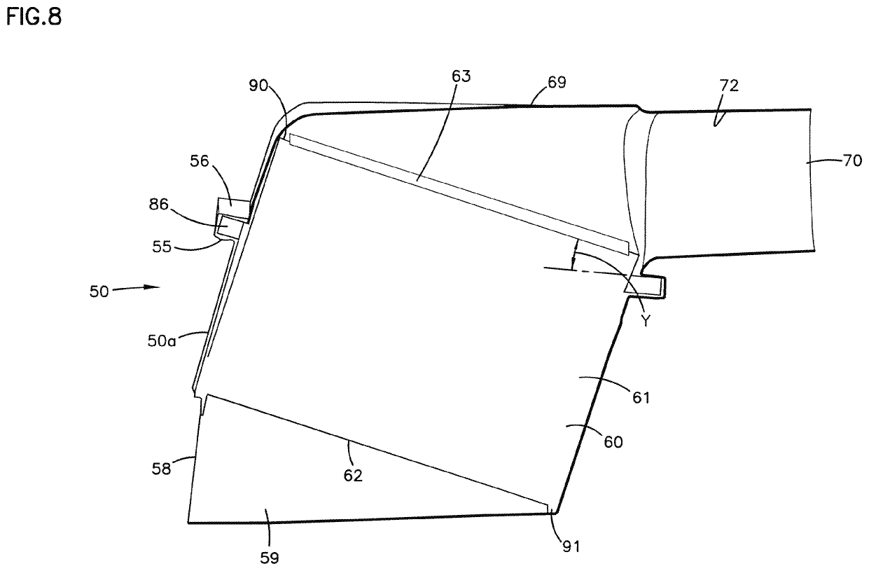

An example of mounting is shown in FIG. 8. Referring to FIG. 8, housing seal arrangement 80 is shown on media pack 61 of cartridge 60. The seal arrangement 80 could be configured to be positioned between flanges 55, 56, for sealing. The seal arrangement 80 is positioned in a plane not parallel to inlet face 62 and outlet face 63, in extension across a face that would correspond to the face viewable at 66, FIG. 6. In general, this face would comprise a first one of a sheet of facing or fluted (typically corrugated) material, and the opposite face, typically, a second one of sheet of facing or fluted (typically corrugated) material, although coverings or other materials can be provided.

The angle between the seal arrangement 80 and the outlet face 63 is generally shown at Y, FIG. 8, and would typically be at least 5° and usually within the range of 8° to 45°, inclusive, for example 8°-20°, inclusive.

It is noted that for the arrangement of FIGS. 1 and 2, at least 10% of the volume of the media pack 81 is positioned in each of: the inlet section 51 and the outlet section 52. Often at least 15% of each is so located.

Referring to FIG. 7, it is noted that for the arrangement shown, apex 90 of cartridge 61 is positioned at a highest location. Apex 90 comprises a corner or vertex formed between outlet flow face 63 and end 64.

Similarly, apex 91 is positioned in section 59, i.e., at a lowest location. Apex 91 comprises a corner diagonally opposite apex 90, and comprises a corner between inlet face 62 and end 65.

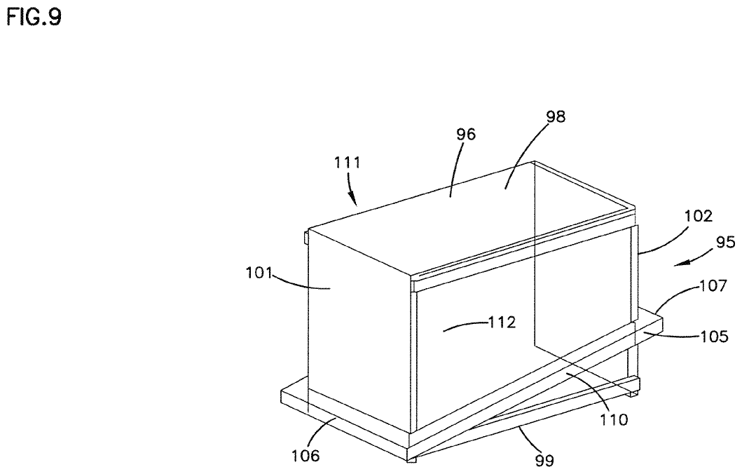

Attention is now directed to FIG. 9. In FIG. 9 a schematic perspective view of the filter cartridge 95, useable as cartridge 60. Referring to FIG. 9, cartridge 95 comprises media pack 96 with opposite flow faces 98, 99. The media pack 96 would typically and preferably comprise a blocked stacked arrangement of z-filter media strips, each strip comprising a section of corrugated sheet secured to a section of facing sheet. Ends of the strips form opposite end faces 101, 102. The end faces 101, 102 would typically be sealed, for example by covering with end pieces as shown.

Housing seal arrangement 105 is viewable. The housing seal arrangement 105 includes sections 106, 107 extending across ends 101, 102, respectively. It also includes an extension 110 and opposite extension 111, not viewable in FIG. 9, for engagement with the housing.

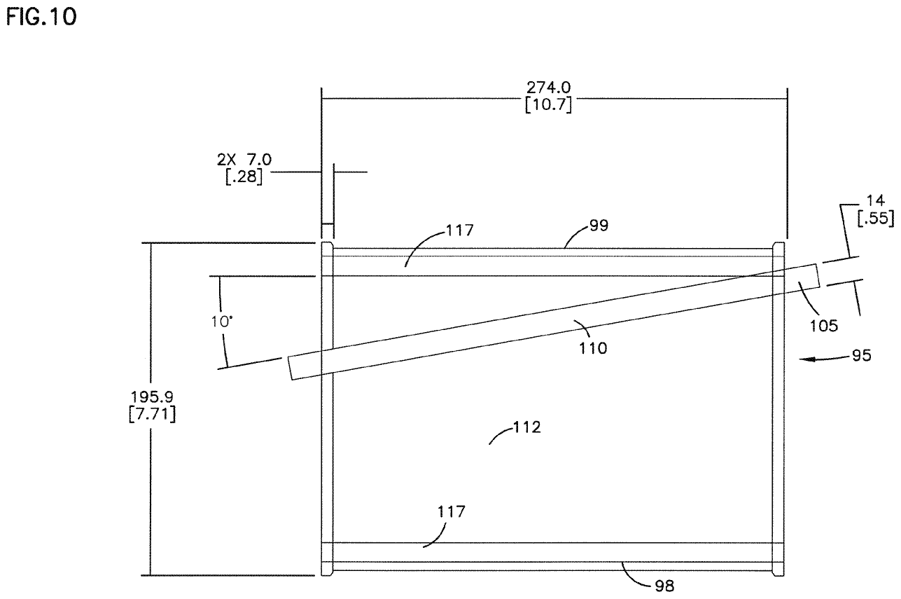

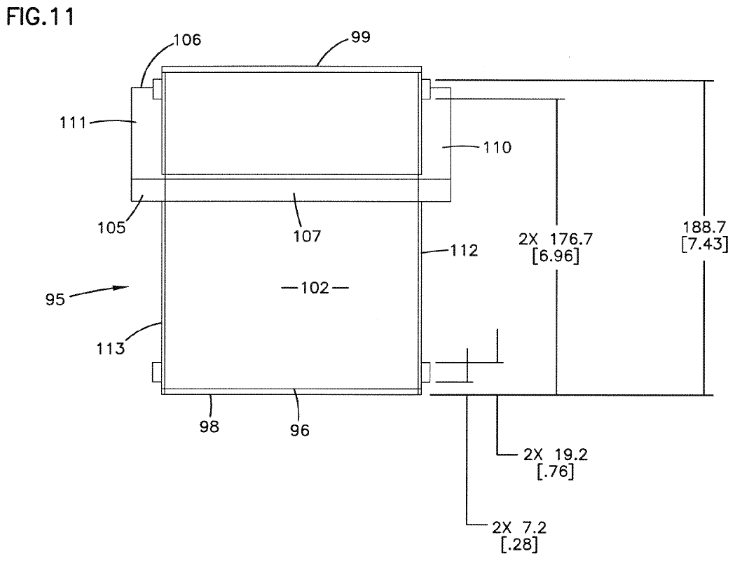

In FIG. 10, the side view of cartridge 95 is depicted. The view of FIG. 10 would be toward side 112, FIG. 9, but inverted. In FIG. 10, a pair of spaced extensions or spacers 117, extending between ends 101, 102 is viewable. A second pair could also be positioned oppositely, i.e., on a surface 113, FIG. 11, opposite to surface 112.

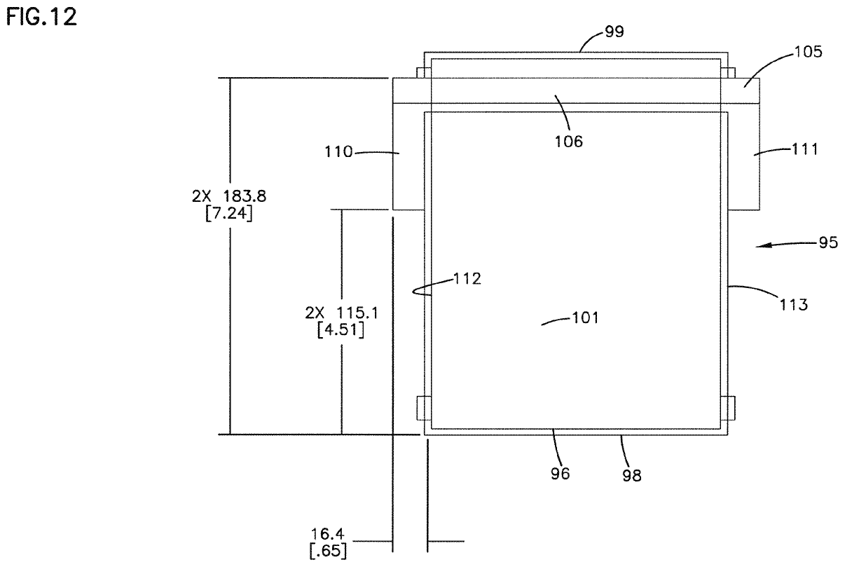

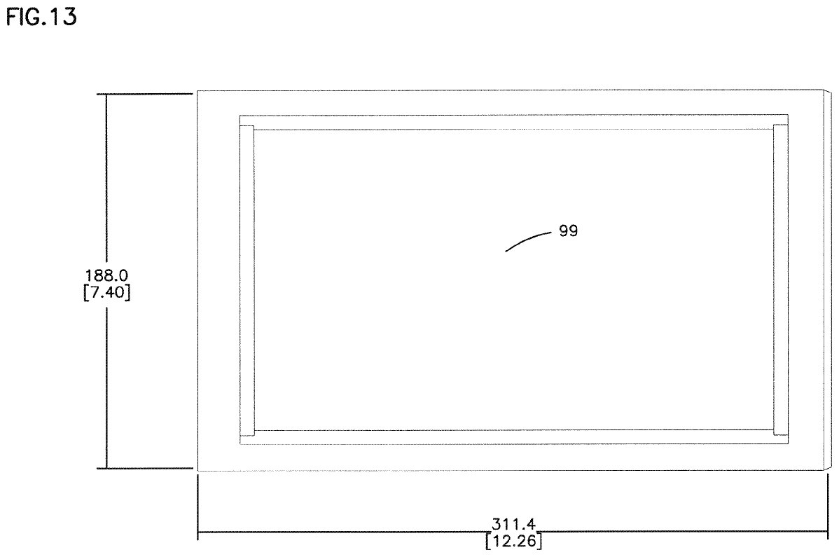

In FIG. 11, a view toward end section 107 is provided. In FIG. 12 the view is toward end section 106 (inverted relatively to FIG. 9). In FIG. 13 the view toward outlet face 99 is shown.

In FIGS. 10-13, dimensions are shown in millimeters (and inches in brackets) to indicate an example size. Of course a variety of alternate sizes can be made.

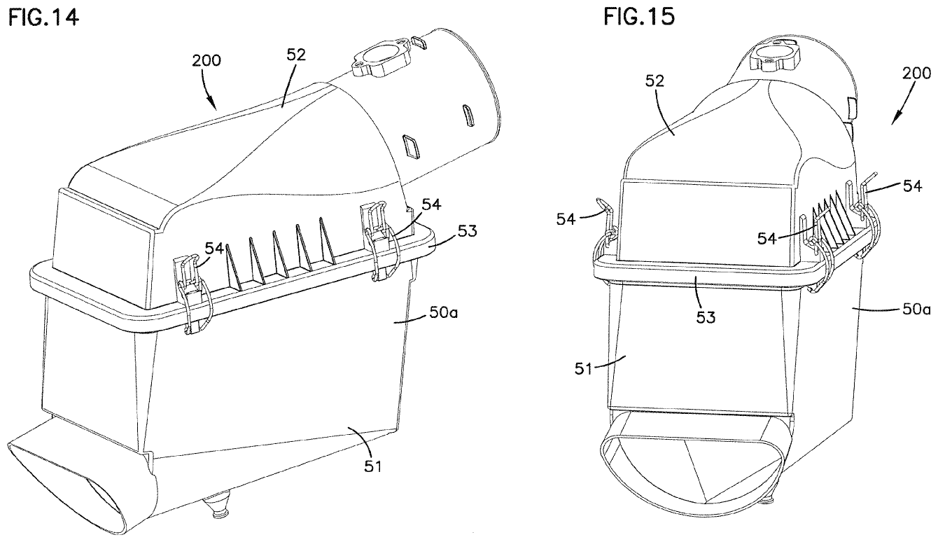

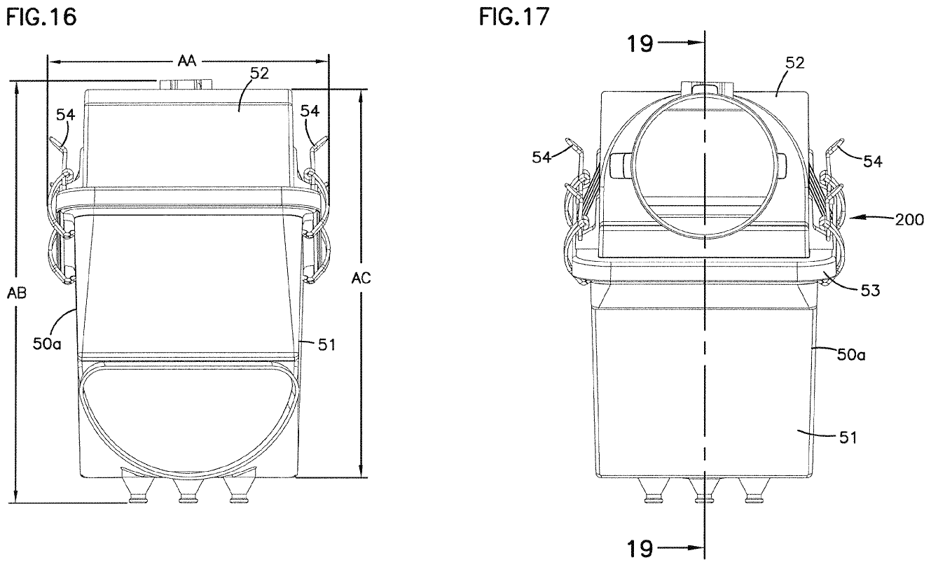

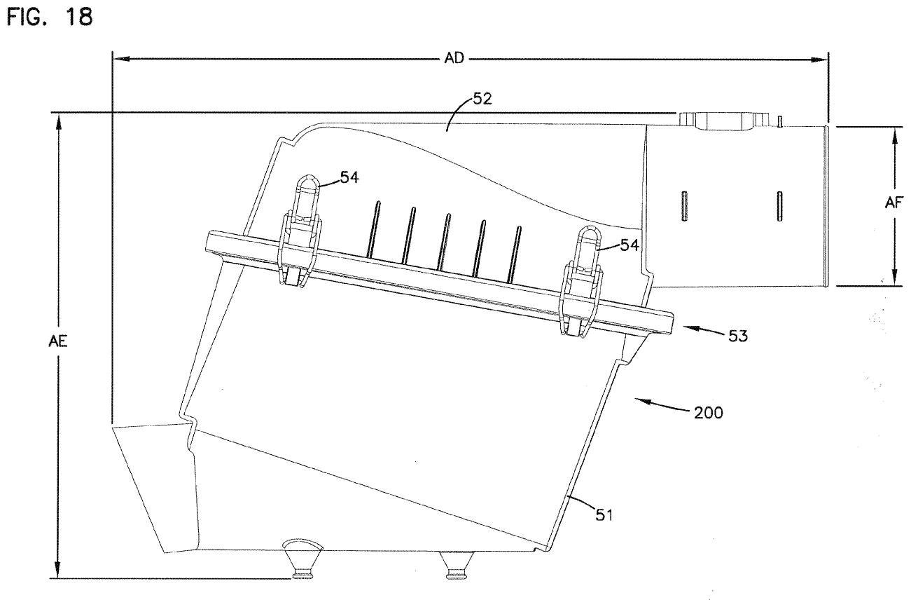

### IV. A Second Example Air Cleaner Systems, FIGS. 14-23

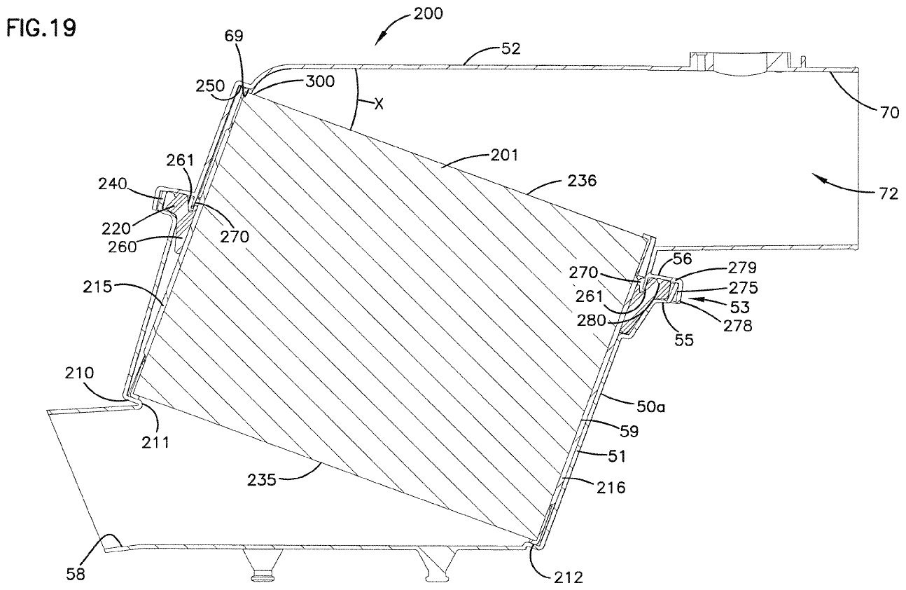

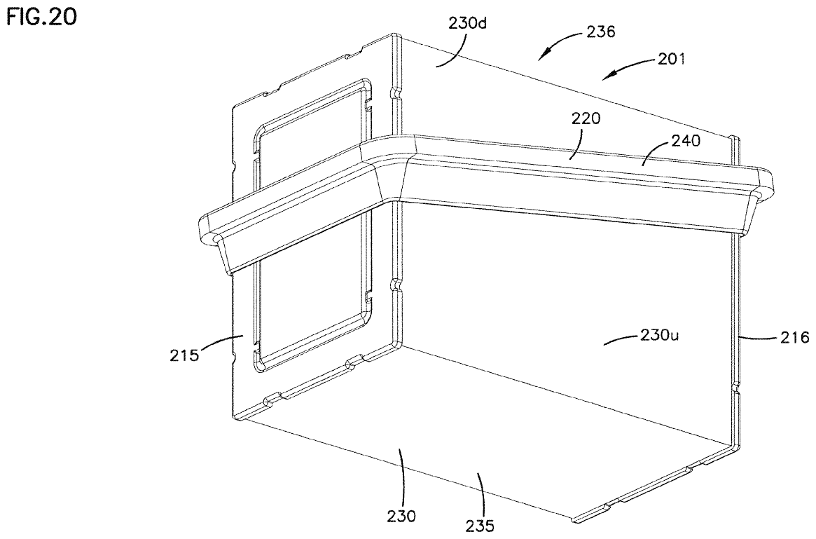

In FIGS. 14-23, a second example air cleaner system is depicted. In FIGS. 14-19, the air cleaner assembly 200 is viewable. In FIGS. 20-23, a removable and replaceable filter cartridge 201 useable in the air cleaner 200 is provided. Many of the features of the air cleaner 200 are analogous features to those discussed previously for air cleaner 50, FIGS. 2-8, and many of the features are provided with the same reference numerals in FIGS. 14-19. Thus the air cleaner arrangement 200 comprises housing 50a including an inlet section 51 and an outlet section 52. The inlet section 51 and outlet section 52 are secured to one another along housing separation region 53. Clamps 54 are used to secure separation region 53. Referring to FIG. 19, the housing separation 53 comprises a flange 55 on the inlet section 51, and a flange 56 on the outlet section 52, sized and configured to engage one another. Unhooking clamps 54, FIGS. 14-18, allow separation of flanges 55, 56 (and thus section 51 and 52) to obtain service access to an interior housing 50a. This allows for servicing of cartridge 201, for example by replacement, FIG. 19.

The inlet section 51 includes an air flow inlet 58 and a filter cartridge receiving section 59. The outlet section 52 includes a filter cartridge receiving section 69 and an outlet tube 70. For the particular arrangement shown, the inlet tube 58 and outlet tube 70 extend in generally opposite directions from one another. Alternate constructions are possible.

In the assembly, inside the tube 70, (or in a related duct work), at or near region 72, a probe of a mass air flow sensor system (MAFS) could be positioned, to evaluate air flow in outlet tube 70.

Referring to FIG. 19, attention is directed to the following features. First housing section 51 includes a lower support ledge or shelf arrangement 210 comprising shelves 211 and 212. When filter cartridge 201 is positioned within housing 50a, opposite side panels 215, 216 will respectively rest on ledges 211, 212, for support. Thus cartridge 201 is not suspended by the seal arrangement 220. Rather, the cartridge 201 is supported by engagement of the panels 215, 216 with the ledge arrangement 210.

The filter cartridge 201 will be generally understood by reference to FIGS. 20-23. Referring first to FIG. 20, cartridge 201 comprises a media pack 230 having side panels 215 and 216. The media pack 230 would generally comprise a stacked arrangement of single facer material comprising fluted (corrugated) media secured to facing media with opposite upstream and downstream flute seal arrangements appropriate to define a series of inlet flutes and outlet flutes extending between opposite faces 235, 236 in accord with previous discussions. This prevents unfiltered air entering face 235 from leaving via face 236, without passage through media, for filtering. The particular media pack 230 depicted schematically in FIG. 20, is a “blocked” stacked arrangement, again meaning that no face or side is slanted, rather each engages adjacent ones at 90° angles. Of course, as discussed above slanted arrangements are possible with the principles described herein.

For the particular example shown in FIG. 20, face 235 would be an inlet face for air flow, and opposite face 236 would be an outlet face for filtered air. The panels 215, 216 would typically and preferably be molded-in-place, to seal ends of the single facer strips within the media pack 230. Typically panels 215, 216 would be molded from a polyurethane such as a foamed polyurethane.

In a typical construction approach, the same mold would be used for panels 215, 216, with two molding steps.

Referring to FIG. 20, filter cartridge 201 includes peripheral, perimeter housing seal arrangement 220 thereon. The particular seal arrangement 220 depicted, extends completely around the media pack 230, separating the media pack into an upstream section 230u and a downstream 230d. For a typical example, the seal arrangement 220 would comprise a single integral molded-in-place seal, typically a molded polymeric material such as a foamed polyurethane, made in a one-shot mold process and applied after the panels 215, 216 are in place on the media pack 230. The seal arrangement 220 is provided with an outer flange 240 which, when cartridge 201 is positioned within housing 50a, FIG. 19, is compressed between flanges 55, 56 to form a seal. Such a compression seal is generally referred to herein as a “axial” seal, or by similar terminology, since the force of compression on the seal member 220 is generally parallel to an access of air flow direction through the media pack 201.

The example housing seal arrangements described herein have no rigid structural member embedded therein, and each is molded from a single polymeric material, such as polyurethane. Thus, the housing seal arrangement 220 can be described as consisting essentially of molded polyurethane, typically foamed polyurethane.

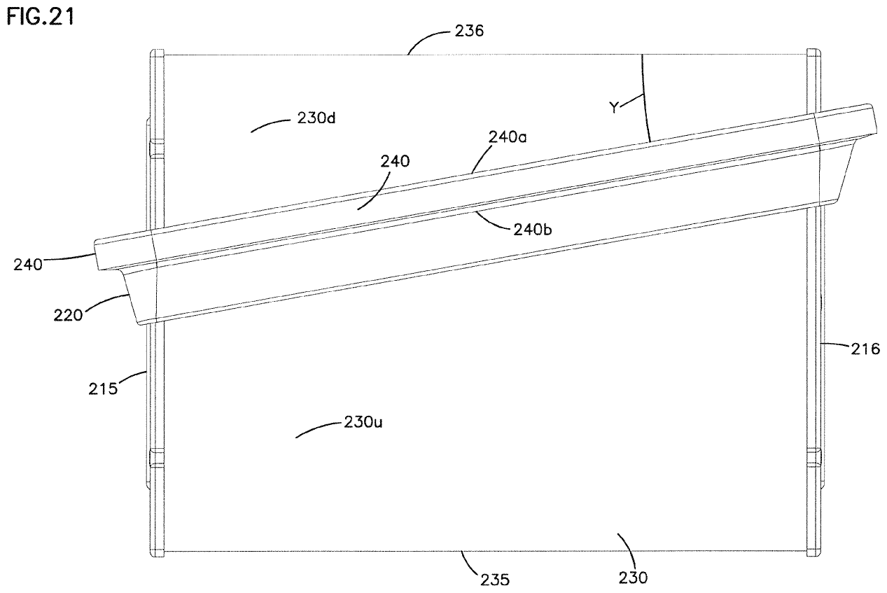

Referring to FIG. 21, seal flange 240 generally extends at an angle Y relative to the outlet face 236 as previously discussed, i.e., typically at least 5° and usually within the range of 8° to 45°, inclusive, for example 8°-20°, inclusive. For the particular example shown the range would typically be 8°-15°, for example about 10°. More generally stated, the angle Y is greater than 0°, and usually not greater than 45°.

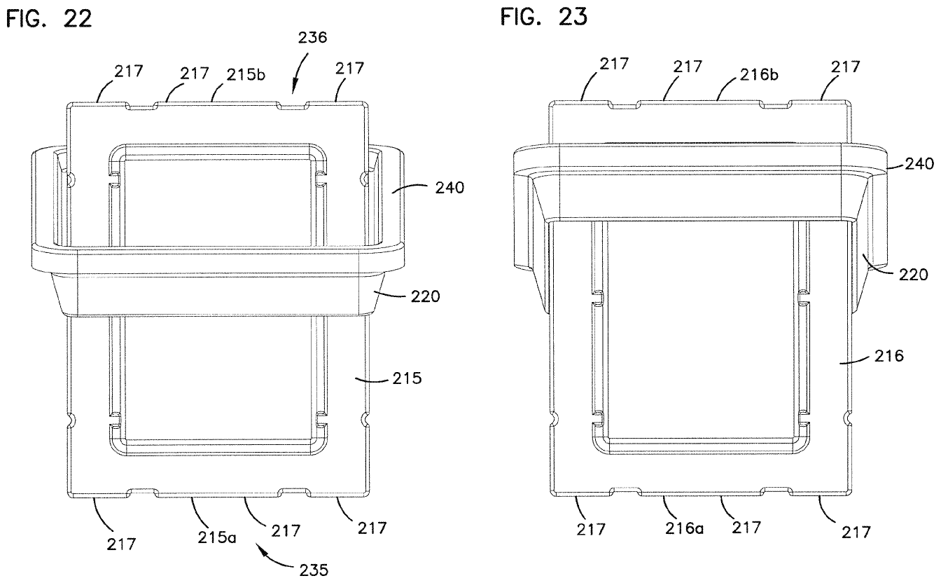

Referring to FIGS. 22 and 23, the configuration of the panels 215, 216 is shown. In particular each panel 215 includes opposite edges 215a, 215b, edge 215a being adjacent inlet face 235 and edge 215b being adjacent outlet face 236. Edges 215a and 215b are provided with projection regions 217 which extend beyond an adjacent face of the media pack. These regions 217 will engage the housing as shown in FIG. 19, for secure positioning of the cartridge, during installation. In particular regions 217 along edge 215a, will engage ledge 211, FIG. 19. Regions 217 along edge 215b will engage cover ledge 250, FIGS. 19, to help secure the cartridge against unintended motion. Ledge 215 is opposite ledge 211, and panel 215 is secured therebetween.

Referring to FIG. 23, panel 216 analogously includes opposite edges 216a and 216b, with projections 217. The projections 217 along edge 216a will be engaged by ledge 212 of FIG. 19, during installation. Projections 217 along edge 216b can be made to not engage structure within the housing, although if desired a ledge structure can be provided adjacent opposite corners, to help secure the cartridge 201 in position.

In FIG. 19, seal arrangement 220 can be seen in cross-section. The seal arrangement 220 includes a base 260, by which the media pack 201 and panels 215, 216 are engaged. Flange 240, which is compressed to form the seal, is secured to base 260. Typically the flange 240 is molded at end base 260, meaning the two are jointly molded from a single material, at the same time.

A trough 261 is provided between the flange 240 and the media pack 201 and panels 215, 216. The trough 261 generally extends toward base 260 and is surrounded by at least a portion of the flange 240. The trough 260 is positioned to receive a flange projection 270 therein, during installation, FIG. 19. The flange projection 270 is secured on one of the housing sections 51, 52, in this example the downstream housing section 52.

The trough 261 is generally configured to have a maximum depth of at least 3 mm, usually at least 4 mm and typically at least 5 mm. Examples would be 5-14 mm, although alternatives are possible.

Still referring to FIG. 19, flange 55 is configured to receive therein seal arrangement 220 during installation. Flange 55 includes an outer projection 275 which will surround flange 240, during installation. Flange 275 is of a sufficient length to bottom out against a portion of cover section 52, during installation.

Still referring to FIG. 19, cover section 52 includes flange arrangement 56 including inner projection 270 and outer projection 278. The inner projection 270, again, is sized to extend into trough 261. The outer projection 278 is sized to extend around projection 275, during installation. Flange 279 extending between projections 270, 278, provides a surface against which flange 275 can bottom out, during installation.

It is noted that radially outwardly projecting flange 279 includes projection 280 thereon, sized to press into axial seal flange 240, to help ensure seal. Such a projection will generally extend into the flange 240 a distance corresponding to at least 2% of the compressed thickness of the flange 240 between opposite walls 240a, 240b, FIG. 21.

Referring to FIG. 19, angle X indicates the angle between the outlet flow face 236 and the outlet tube 70. The angle is typically at least 10°, usually at least 15° and often within the range of 15° to 80°, inclusive, for example 15°-45°. As a result of angle X, outlet face 236 can be viewed as tipped toward outlet tube 70, with an apex of the media pack indicated at 300 corresponding to a portion of the media pack 201 highest within housing 50a, and positioned to tip face 236 toward outlet tube 70.

For the example of FIGS. 14-23, some example dimensions are provided, as follows: AA=217.1 mm; AB=328.0 mm; AC=301.5 mm; AD=500.9 mm; AE=328.4 mm; AF=112.1 mm.

An example material useable for both the seal and the side moldings described herein is polyurethane. An example polyurethane characterized is a foamed polyurethane which will increase in volume during use. Preferred ones increase by at least 40% in volume, to fill the mold cavities (typically at least 80% in volume) and having an as-molded density of no greater than 30 lbs/cu.ft (0.48 g/cc), typically no greater than 22 lbs/cu.ft. (0.35 g/cc) and usually with in the range of 10 lbs/cu.ft (0.16 g/cc) to 22 lbs/cu.ft (0.35 g/cc); and, a hardness (Shore A) typically of not greater than 30, preferably not greater than 25 and typically within the range of 10 to 22. Of course polyurethanes outside of this range can be used, but the characterized ones are advantageous for manufacturing and handling.

1.-26. (canceled)

27. An air filter cartridge comprising:
(a) a filter media pack comprising filter media and having an air inlet flow face and an air outlet flow face opposite the air inlet flow face, and a central flow axis through the air inlet flow face and the air outlet flow face;
(i) the filter media pack having a rectangular cross-sectional shape in a direction perpendicular to the central flow axis; and
(ii) the filter media pack comprising four sides, including a first pair of first and second opposite sides and a second pair of first and second opposite sides, extending between the air inlet flow face and the air outlet flow face;
(b) first and second side pieces positioned on the first pair of first and second opposite sides of the filter media pack, respectively, wherein:
(i) the first and second side pieces being configured to seal the first pair of first and second opposite sides of the filter media pack against air flow through the first pair of first and second opposite sides of the filter media pack; and
(c) a housing seal arrangement for sealing the air filter cartridge to an air cleaner housing, in use, wherein:
(i) the housing seal arrangement comprises a seal member that forms a pinch seal between housing pieces, in use;
(ii) the seal member extends across the second pair of first and second opposite sides of the media pack so that the seal member extending across the second pair of first and second opposite sides of the media pack is arranged in a plane that is non-parallel to a plane perpendicular to the central flow axis; and
(iii) the pinch seal, along a complete extension around the media pack, is spaced, along the central flow axis, from each of the first flow face and the second flow face.

28. An air filter cartridge according to claim 27 wherein:
(a) the filter media pack comprises alternating fluted media and facing media.

29. An air filter cartridge according to claim 28 wherein:
(a) the alternating fluted media and facing media are secured to each other at one end of the first flow face and the second flow faces.

30. An air filter cartridge according to claim 28 wherein:
(a) the alternating fluted media and facing media comprises a stack of alternating strips of a fluted media sheet secured to a facing media sheet.

31. An air filter cartridge according to claim 27 wherein:
(a) the housing seal arrangement further comprises a receiving trough positioned inwardly from the seal member that forms a pinch seal.

32. An air filter cartridge according to claim 27 wherein:
(a) the first and second side pieces each comprise a surface spaced from the air outlet flow face of the filter media pack in a direction away from the air inlet flow face of the filter media pack.

33. An air filter cartridge according to claim 32 wherein:
(a) the surfaces of the first and second side pieces include portions located beyond the air outlet flow face of the filter media pack are constructed to not engage an air cleaner housing, in use.

34. An air filter cartridge according to claim 27 wherein:
(a) the seal member extends across the first pair of first and second sides of the filter media pack and across the second pair of the first and second sides of the filter media pack.

35. An air filter cartridge according to claim 32 wherein:
(a) the surfaces of the first and second side pieces located beyond the outlet flow face of the filter media pack comprise a plurality of bumps.

36. An air filter cartridge according to claim 32 wherein:
(a) the surfaces of the first and second side pieces located beyond the outlet flow face of the filter media pack comprise a plurality of recesses.

37. An air filter cartridge according to claim 27 wherein:
(a) the first and second side pieces are molded in place on the first pair of first and second opposite sides of the filter media pack.

38. An air filter cartridge according to claim 27 wherein:
(a) the first and second side pieces comprise preforms attached to the media pack by a potting material.

39. An air filter cartridge according to claim 32 wherein:
(a) the surfaces of the first and second side pieces spaced from the air outlet flow face of the filter media pack are spaced at least 0.5 mm from the air outlet flow face of the filter media pack.

40. An air filter cartridge according to claim 32 wherein:
(a) the surfaces of the first and second side pieces spaced from the air outlet flow face of the filter media pack are spaced at least 1 mm from the air outlet flow face of the filter media pack.

41. An air filter cartridge according to claim 32 wherein:
(a) the surfaces of the first and second side pieces spaced from the air outlet flow face of the filter media pack are spaced 1.5 mm to 3.5 mm from the air outlet flow face of the filter media pack.

42. An air filter cartridge according to claim 27 wherein:
(a) a portion of the seal member extends parallel to the air inlet flow face of the filter media pack.

43. An air filter cartridge according to claim 27 wherein:
(a) a portion of the seal member extends at an angle of greater than 0 degrees to a plane perpendicular to the central flow axis.

43. An air filter cartridge according to claim 27 wherein:
(a) the seal member extends at an angle of at least 5 degrees to 45 degrees to a plane perpendicular to the central flow axis.

44. An air filter cartridge according to claim 27 further comprising:
(a) a protective material located over the second pair of first and second sides of the filter media pack.

45. An air filter cartridge according to claim 44 wherein:
(a) the protective material is secured in place against the filter media pack by molding the first and second side pieces to the first pair of opposite sides of the filter media pack.

46. An air filter cartridge according to claim 44 wherein:
(a) the protective material comprises cardboard or plastic.

47. An air filter cartridge according to claim 27 wherein:
(a) at least 30% of the second pair of first and second opposite sides of the filter media pack is uncovered.

48. An air filter cartridge according to claim 27 wherein:
(a) at least 40% of the second pair of first and second opposite sides of the filter media pack is uncovered.

49. An air filter cartridge according to claim 27 wherein:
(a) the first and second side pieces have an as-molded density of no greater than about 30 lbs/ft³.

50. An air filter cartridge according to claim 27 wherein:
(a) the first and second side pieces have a hardness, Shore A, of no greater than about 30.

51. An air filter cartridge according to claim 27 wherein:
(a) the first pair of first and second opposite sides being longer than the second pair of first and second opposite sides.

52. An air filter cartridge comprising:
(a) a filter media pack comprising filter media and having an air inlet flow face and an air outlet flow face opposite the air inlet flow face, and a central flow axis through the air inlet flow face and the air outlet flow face;
(i) the filter media pack having a rectangular cross-sectional shape in a direction perpendicular to the central flow axis; and
(ii) the filter media pack comprising four sides, including a first pair of first and second opposite sides and a second pair of first and second opposite sides, extending between the air inlet flow face and the air outlet flow face;
(b) first and second side pieces positioned on the first pair of first and second opposite sides of the filter media pack, respectively, wherein:
(i) the first and second side pieces being configured to seal the first pair of first and second opposite sides of the filter media pack against air flow through the first pair of first and second opposite sides of the filter media pack; and
(ii) the first and second side pieces each comprise a surface spaced from the air outlet flow face of the filter media pack in a direction away from the air inlet flow face of the filter media pack; and
(c) a housing seal arrangement for sealing the air filter cartridge to an air cleaner housing, in use, wherein:
(i) the housing seal arrangement comprises a seal member that forms a pinch seal between housing pieces, in use;
(ii) the seal member extends across the filter media pack first pair of first and second opposite sides and across the filter media pack second pair of first and second sides; and
(ii) the seal member that extends across the second pair of first and second opposite sides of the media pack is arranged in a plane that is non-parallel to a plane perpendicular to the central flow axis.

53. An air filter cartridge according to claim 52 wherein:
(a) the filter media pack comprises alternating fluted media and facing media.

54. An air filter cartridge according to claim 53 wherein:
(a) the alternating fluted media and facing media are secured to each other at one end of the first flow face and the second flow faces.

55. An air filter cartridge according to claim 53 wherein:
(a) the alternating fluted media and facing media comprises a stack of alternating strips of a fluted media sheet secured to a facing media sheet.

56. An air filter cartridge according to claim 52 wherein:
(a) the housing seal arrangement further comprises a receiving trough positioned inwardly from the seal member that forms a pinch seal.

57. An air filter cartridge according to claim 52 wherein:
(a) the surfaces of the first and second side pieces include portions located beyond the air outlet flow face of the filter media pack are constructed to not engage an air cleaner housing, in use.

58. An air filter cartridge according to claim 52 wherein:
(a) the first pair of first and second opposite sides being longer than the second pair of first and second opposite sides.

59. An air filter cartridge according to claim 52 wherein:
(a) the pinch seal, along the complete extension around the media pack, is spaced, along the central flow axis, from each of the first flow face and the second flow face.
